(19) United States
(12) Patent Application Publication
(10) Pub. No.: US 2011/0320781 A1
(43) Pub. Date: Dec. 29, 2011

(54) DYNAMIC DATA SYNCHRONIZATION IN THREAD-LEVEL SPECULATION

(76) Inventors: Wei Liu, San Jose, CA (US); Youfeng Wu, Palo Alto, CA (US)

(21) Appl. No.: 12/826,287

(22) Filed: Jun. 29, 2010

(51) Int. Cl. G06F 9/312; G06F 12/02; G06F 12/08

(52) U.S. Cl. 712/225; 711/125; 711/105; 711/E12.007; 711/E12.017; 712/E09.033

(57) ABSTRACT

In one embodiment, the present invention introduces a speculation engine to parallelize serial instructions by creating separate threads from the serial instructions and inserting processor instructions to set a synchronization bit before a dependence source and to clear the synchronization bit after a dependence source, where the synchronization bit is designed to stall a dependence sink from a thread running on a separate core. Other embodiments are described and claimed.

### BACKGROUND

In modern processors, it is common to have multiple computing cores capable of executing in parallel. However, many sequential or serial applications and programs fail to exploit parallel architectures effectively. Thread-level speculation (TLS) is a promising technique to parallelize sequential programs with static or dynamic compilers and hardware to recover if mis-speculation happens. Without proper synchronization, however, between dependent load and store instructions, for example, loads may execute before stores and cause data violations that squash the speculative threads and require re-execution with re-loaded data.

### BRIEF DESCRIPTION OF THE DRAWINGS

FIG. 1 is a block diagram of an example system in accordance with one embodiment of the present invention.

FIG. 2 is a block diagram of an example speculation engine in accordance with an embodiment of the present invention.

FIGS. 3A and 3B are block diagrams of example software code in accordance with an embodiment of the present invention.

FIG. 4 is a flow chart for dynamic data synchronization in thread-level speculation in accordance with an embodiment of the present invention.

FIG. 5 is a block diagram of a system in accordance with an embodiment of the present invention.

### DETAILED DESCRIPTION

In various embodiments, a processor is introduced with a speculative cache with synchronization bits that, when set, can stall a read of the cache line or word. One skilled in the art would recognize that this may prevent mis-speculation and the associated inefficiencies of squashed threads. Also presented are processor instructions to set and clear the synchronization bits. Compilers may take advantage of these instructions to synchronize data dependencies. The present invention is intended to be practiced in processors and systems that may include additional parallelization and/or thread speculation features.

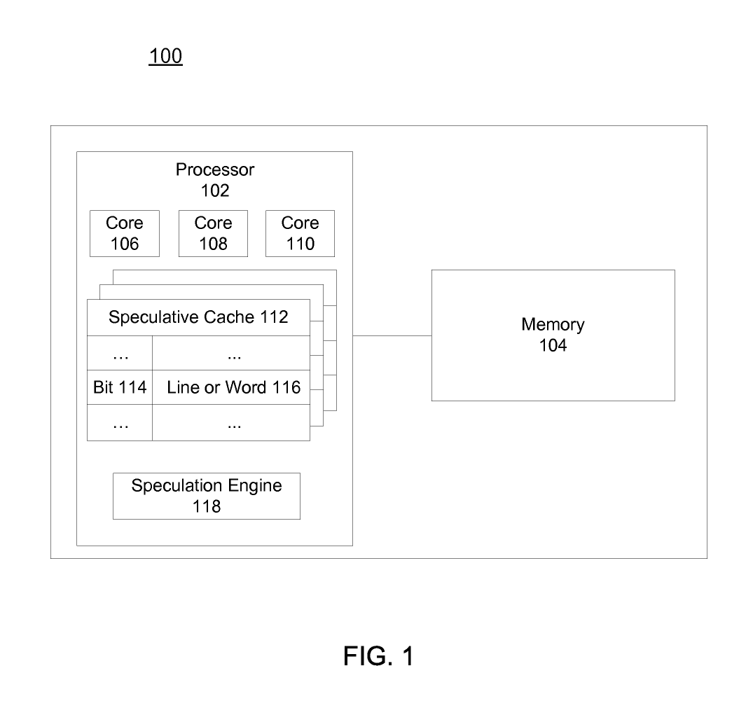

Referring now to FIG. 1, shown is a block diagram of an example system in accordance with one embodiment of the present invention. As shown in FIG. 1, system 100 may include processor 102 and memory 104, such as dynamic random access memory (DRAM). Processor 102 may include cores 106-110, speculative cache 112 and speculation engine 118. Cores 106-110 may be able to execute instructions independently from one another and may include any type of architecture. While shown as including three cores, processor 102 may have any number of cores and may include other components or controllers, not shown. In one embodiment, processor 102 is a system on a chip (SOC).

Speculative cache 112 may include any number of separate caches and may contain any number of entries. While intended as a low latency level one cache, speculative cache 112 may be implemented in any memory technology at any hierarchical level. Speculative cache 112 includes synchronization bit 114 associated with cache line or word 116. When synchronization bit 114 is set, as described in greater detail hereinafter, line or word 116 would not be able to be loaded by a core, because, for example, another core may be about to perform a store upon which the load depends. In one embodiment, a core trying to load from cache line or word 116 when synchronization bit 114 is set would stall until synchronization bit 114 is cleared.

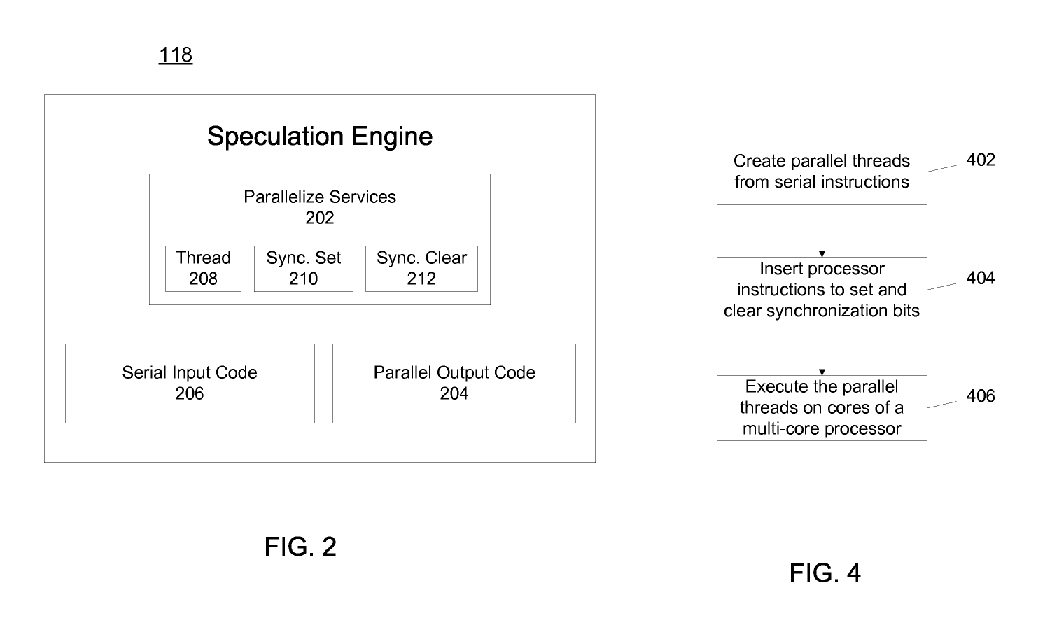

Speculation engine 118 may implement a method for dynamic data synchronization in thread-level speculation, for example as described in reference to FIG. 4, and may have an architecture as described in reference to FIG. 2. Speculation engine 118 may be separate from processor 102 and may be implemented in hardware, software or a combination of hardware and software.

Referring now to FIG. 2, shown is a block diagram of an example speculation engine in accordance with an embodiment of the present invention. As shown in FIG. 2, speculation engine 118 may include parallelize services 202, parallel output code 204 and serial input code 206. Parallelize services 202 may provide speculation engine 118 with the ability to parallelize serial instructions and add dynamic data synchronization in thread-level speculation.

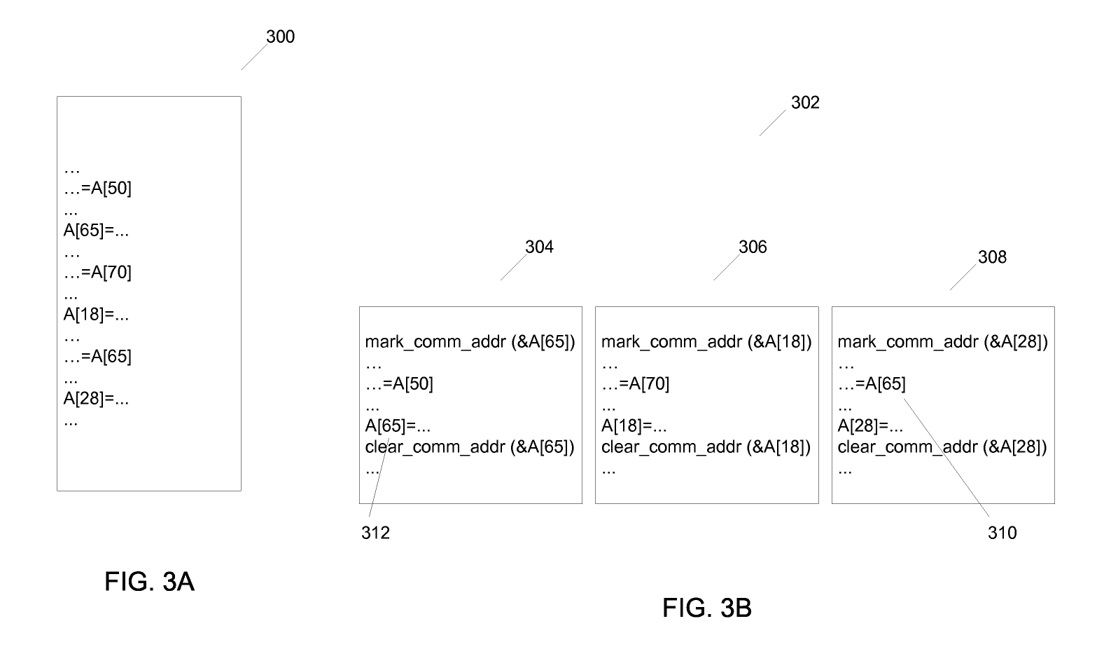

Parallelize services 202 may include thread services 208, synchronization set services 210, and synchronization clear services 212 which may create parallel threads from serial instructions, insert processor instructions to set synchronization bits before dependence sources, and insert processor instructions to clear synchronization bits after dependence sources, respectively. Parallelize services 202 may create parallel output code 204 (for example as shown in FIG. 3B) from serial input code 206 (for example as shown in FIG. 3A).

Referring now to FIGS. 3A and 3B, shown are block diagrams of example software code in accordance with an embodiment of the present invention. As shown in FIG. 3A, sequential instructions 300 include various loads and stores that progress serially and are intended to be executed by a single core of a processor. Sequential instructions 300 may serve as serial input code 206 of speculation engine 118. As shown in FIG. 3B, parallel instructions 302 may represent parallel output code 204 of speculation engine 118. Threads 304-308 may be able to be executed separately by cores 106-110.

Threads 304-308 may each include a processor instruction (mark_comm_addr for example) which, when executed, sets the synchronization bit 114 for a particular cache line or word 116 before a dependence source, such as a store instruction. Threads 304-308 may also each include a corresponding processor instruction (clear_comm_addr for example) which, when executed, clears the synchronization bit 114 after the dependence source. An example of a data dependence can be seen in threads 304 and 308, where a dependence sink would have to wait for a dependence source to complete and clear the synchronization bit. In this case load 310 would stall the progress of thread 308 until store 312 is completed and thread 304 clears the associated synchronization bit.

Referring now to FIG. 4, shown is a flow chart for dynamic data synchronization in thread-level speculation in accordance with an embodiment of the present invention. As shown in FIG. 4, the method begins with creating (402) parallel threads from serial instructions. In one embodiment, thread services 208 is invoked to generate parallel instructions 302 from sequential instructions 300. In another embodiment, the number of threads (304-308) generated is based at least in part on the number of cores (106-110) in a processor.

The method continues with inserting (404) processor instructions to set and clear synchronization bits. In one embodiment, synchronization set services 210 inserts instructions (mark_comm_addr) into threads 304-308 at an early point before the dependence source or potential dependence source when an address is generated. In another embodiment, synchronization clear services 212 inserts instructions (clear_comm_addr) into threads 304-308 after the dependence source or potential dependence source.

The method concludes with executing (406) the parallel threads on cores of a multi-core processor. In one embodiment, threads 304-308 are executed on cores 106-110, respectively. In one embodiment, the execution of core 110 may stall on load 310 until synchronization bit 114 is cleared by thread 304 executing on core 106.

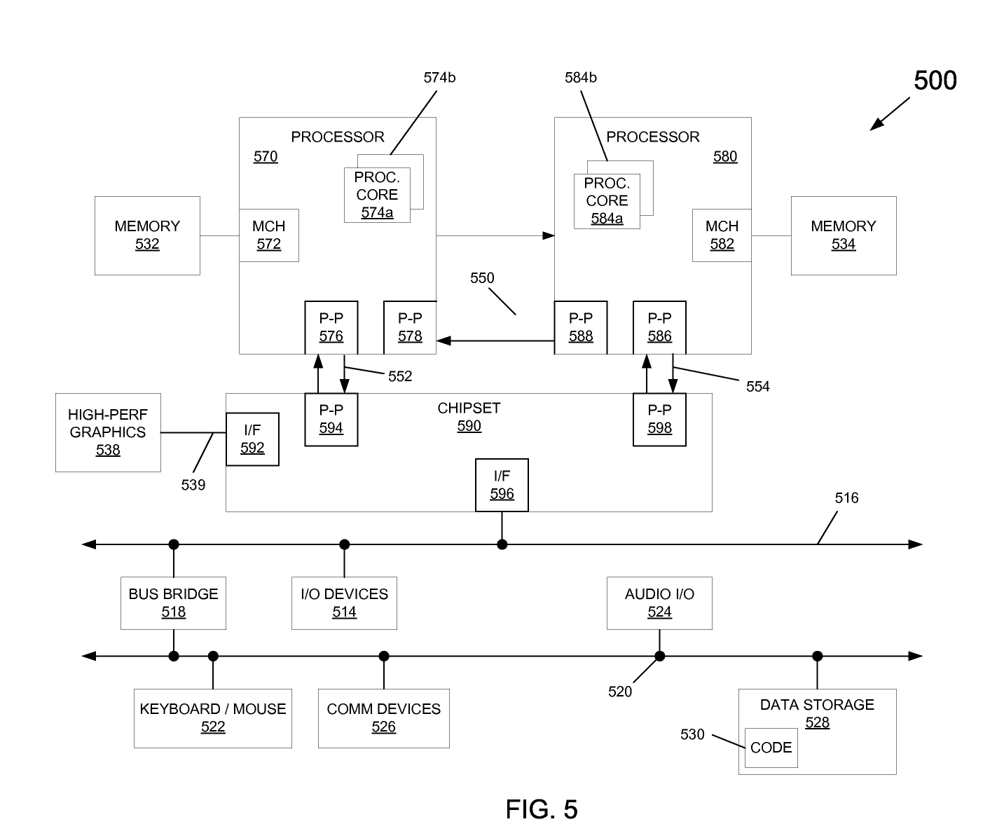

Embodiments may be implemented in many different system types. Referring now to FIG. 5, shown is a block diagram of a system in accordance with an embodiment of the present invention. As shown in FIG. 5, multiprocessor system 500 is a point-to-point interconnect system, and includes a first processor 570 and a second processor 580 coupled via a point-to-point interconnect 550. As shown in FIG. 5, each of processors 570 and 580 may be multicore processors, including first and second processor cores (i.e., processor cores 574a and 574b and processor cores 584a and 584b). Each processor may include dynamic data synchronization thread-level speculation hardware, software, and firmware in accordance with an embodiment of the present invention.

Still referring to FIG. 5, first processor 570 further includes a memory controller hub (MCH) 572 and point-to-point (P-P) interfaces 576 and 578. Similarly, second processor 580 includes a MCH 582 and P-P interfaces 586 and 588. As shown in FIG. 5, MCH's 572 and 582 couple the processors to respective memories, namely a memory 532 and a memory 534, which may be portions of main memory (e.g., a dynamic random access memory (DRAM)) locally attached to the respective processors, each of which may include extended page tables in accordance with one embodiment of the present invention. First processor 570 and second processor 580 may be coupled to a chipset 590 via P-P interconnects 552 and 554, respectively. As shown in FIG. 5, chipset 590 includes P-P interfaces 594 and 598.

Furthermore, chipset 590 includes an interface 592 to couple chipset 590 with a high performance graphics engine 538. In turn, chipset 590 may be coupled to a first bus 516 via an interface 596. As shown in FIG. 5, various I/O devices 514 may be coupled to first bus 516, along with a bus bridge 518 which couples first bus 516 to a second bus 520. Various devices may be coupled to second bus 520 including, for example, a keyboard/mouse 522, communication devices 526 and a data storage unit 528 such as a disk drive or other mass storage device which may include code 530, in one embodiment. Further, an audio I/O 524 may be coupled to second bus 520.

Embodiments may be implemented in code and may be stored on a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A storage medium comprising content which, when executed by an accessing machine, causes the accessing machine to:
execute instructions in a first core of a multi-core processor;
determine an address of a data in a speculative cache as part of a dependence sink; and
wait to access the data if a synchronization bit associated with the data has been set by a dependence source in a second core.

2. The storage medium of claim 1, further comprising content which, when executed by an accessing machine, causes the accessing machine to set the synchronization bit by executing a processor instruction.

3. The storage medium of claim 2, further comprising content which, when executed by an accessing machine, causes the accessing machine to clear the synchronization bit by executing a processor instruction.

4. The storage medium of claim 3, wherein the dependence sink comprises a load instruction.

5. The storage medium of claim 3, wherein the dependence source comprises a store instruction.

6. The storage medium of claim 3, wherein the synchronization bit associated with the data comprises a cache line bit.

7. The storage medium of claim 3, wherein the synchronization bit associated with the data comprises a cache word bit.

8. The storage medium of claim 3, wherein the content to set the synchronization bit by executing a processor instruction comprises content to set the synchronization bit when a dependence source address is generated.

9. A system comprising:
a processor including a first core and a second core to execute instructions;
a speculative cache to store data and instructions for the processor, the speculative cache including synchronization bits to indicate if associated data is subject to a dependence source and to stall dependence sink operations when a synchronization bit is set;
a dynamic random access memory (DRAM) coupled to the processor, the DRAM to store serial instructions; and
a speculation engine, the speculation engine to parallelize the serial instructions by creating separate threads and inserting processor instructions to set the synchronization bits before a dependence source.

10. The system of claim 9, further comprising the speculation engine to insert corresponding processor instructions to clear the synchronization bits after a dependence source.

11. The system of claim 10, wherein the dependence source comprises a store instruction.

12. The system of claim 10, wherein the dependence sink comprises a load instruction.

13. The system of claim 9, wherein the synchronization bits comprise cache line bits.

14. The system of claim 9, wherein the synchronization bits comprise cache word bits.

15. A method performed by a specialized speculation engine comprising:
creating parallelized threads from a set of serial instructions;
inserting processor instructions in the threads to set synchronization bits before a dependence source and to clear the synchronization bits after the dependence source, wherein the synchronization bits are designed to stall a dependence sink when set; and
executing the parallelized threads on cores of a multi-core processor.

16. The method of claim 15, wherein the dependence source comprises a store instruction.

17. The method of claim 15, wherein the dependence sink comprises a load instruction.

18. The method of claim 15, wherein the synchronization bits comprise cache line bits.

19. The method of claim 15, wherein the synchronization bits comprise cache word bits.

20. The method of claim 15, wherein inserting processor instructions in the threads to set synchronization bits before a dependence source comprises inserting a processor instruction to set the synchronization bit when a dependence source address is generated.
